(19) United States
(12) Patent Application Publication
(10) Pub. No.: US 2012/0297469 A1
(43) Pub. Date: Nov. 22, 2012

(54) Security Indicator Using Timing to Establish Authenticity

(75) Inventors: Robert Wilson Reeder, Seattle, WA (US); Adam Shostack, Seattle, WA (US)

(73) Assignee: MICROSOFT CORPORATION, Redmond, WA (US)

(21) Appl. No.: 13/112,419

(22) Filed: May 20, 2011

(51) Int. Cl. H04L 9/32; G06F 21/00

(52) U.S. Cl. 726/7

(57) ABSTRACT

The subject disclosure is directed towards authentic timing indicators, comprising data (e.g., an animation) that are output to a user to convey security-related information to the user, using timing to call attention to the authentic timing indicators. For example, a browser program may select and output a particular authentic timing indicator based upon whether a connection to a site is unsecure, secure, or secure and the site has an extended validation certificate; an email program may use authentic timing indicators to highlight signed versus unsigned messages. The authentic timing indicator appears before the content is allowed to control the content pane, increasing the difficulty of spoofing a site, or email message.

### BACKGROUND

Data theft and other computer-related attacks are significant issues. Trustworthy programs thus try to inform users when something related to the security of their computer systems is occurring. To this end, most security information is conveyed to users via textual and graphical indicators on the screen. For example, a web browser's lock icon is a way for the browser to tell the user that there is a secure SSL connection to a website.

However, a problem with trying to make people aware of security relates to presenting security information from trusted software to the user in a way that cannot be spoofed by a malicious third party. More particularly, any application and any content publisher can write anything to the screen. This is sometimes referred to as the “trusted pixels problem”—it is not clear who is writing to any given pixel on screen, so even a familiar indicator such as a lock icon may be faked. Today, criminal attackers spoof such security indicators to gain unwarranted trust. At the same time, even legitimate, well-meaning sites may take advantage of the visual appearance of indicators to help “brand” themselves as trustworthy; for example, many bank websites display lock icons on their login pages. This further confuses users regarding which indicators are real and which are fake.

To overcome the trusted pixels problem, legitimate indicators like the lock icon are supposed to be drawn only in “chrome,” namely the parts of the screen controlled only by trusted software. For example, the lock icon in the Internet Explorer® browser is displayed in the browser's address bar, where websites cannot draw.

However, even when legitimate indicators are only drawn in chrome, they largely fail to convey the desired information, for various reasons. For one, users tend to not notice them, generally because a user's attention is on the content pane, and the chrome is in the user's visual periphery. For another, even if users are aware of such security indicators when they are present, it is the absence of an indicator (not its presence) that a user has to notice to detect an attack; noticing the absence of an indicator is more difficult than noticing its presence. Still further, users also need to remember the correct location of the indicator in the chrome, because attackers may try to fool users with fake, but visually identical, indicators in the content pane. Remembering the correct location of an indicator can be especially difficult, generally because different products and different versions of the same product render security indicators in different places.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which security state associated with content is displayed via an authentic timing indicator at a time that calls the user's attention to the authentic timing indicator, e.g., before allowing the content to control a content output area (e.g., content pane) of a trusted program such as a browser or email program. In general, an authentic timing indicator comprises an output signal from trusted software to a user using any of several possible sensory output modalities; e.g., a visible animation may be used as one type of authentic timing indicator. Example states for a browser program and website content include a secure state (corresponding to a secure connection), a secure state with an extended validation certificate, and an unsecure state. Example states for an email program include a signed message and an unsigned message.

Upon determining which state of a plurality of available states is associated with the content an authentic timing indicator is output for at least one of the states. In one implementation, each state has a corresponding authentic timing indicator output, so that a user does not need to recognize the absence of security information to ascertain the current state.

In one aspect, at least one property of the authentic timing indicator may be based upon user preference data, e.g., to allow personalization. The authentic timing indicator may be presented in the form of an animation, one or more icons, a color scheme, audio output and/or haptic output. The authentic timing indicator may be an animation that provides the appearance of at least one icon moving into a secure screen area of a trusted program (e.g., from the content pane into the browser chrome).

In one aspect, authentic timing indicator logic coupled to a trusted program selects a selected authentic timing indicator based upon security-related information associated with the untrusted content, and uses timing to call attention to the output of the authentic timing indicator relative to output of the untrusted content. For example, the authentic timing indicator may “play” and fade out before or as the content begins to be rendered to the content pane, e.g., the authentic timing indicator is output based upon the security-related information for a first period of time, with at least some of the content rendered in a second period of time that begins after the first period of time begins. An authentic timing indicator may be replayed, e.g., in response to detecting a request made via user interaction, such as if its output is initially missed by the user.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for providing authentic timing indictors.

FIG. 2 is a timing diagram representing example timing of outputting an authentic timing indictor.

FIGS. 3A-3F are example representations (shown at various instants in time) of how an authentic timing indicator may be animated in a browser environment to indicate a secure connection.

FIG. 4 is an example representation of how an authentic timing indicator may be rendered in a browser environment to indicate an unsecure connection.

FIG. 5 is an example representation of how an authentic timing indicator may be rendered in an email environment to indicate a signed email.

FIG. 6 is a flow diagram representing example steps for outputting an authentic timing indicator.

FIG. 7 is a flow diagram representing example steps for determining and outputting a selected authentic timing indicator based upon security-related information known to a browser.

FIG. 8 is a flow diagram representing example steps for determining and outputting a selected authentic timing indicator based upon security-related information known to an email program.

FIG. 9 shows an illustrative example of a computing environment into which various aspects of the present invention may be incorporated.

### DETAILED DESCRIPTION

Various aspects of the technology described herein are generally directed towards authentic timing indicators that output (e.g., display) security information at a moment in time in which the user knows that trusted software, such as a Web browser or email client, is in control of the screen. As a result of the timing, the problem of presenting unspoofable security indicators to users is addressed because the user knows that at that time, the trusted software is in control rather than an untrusted Web publisher or email correspondent.

It should be understood that any of the examples herein are non-limiting. For one, a browser program and an email program are used as examples of trusted software where security is an issue, however other programs such as instant messaging programs, antivirus programs and so forth may benefit from the technology described herein. Further, while a displayed and/or animated security indicator is exemplified in the figures, it is understood that other types of security indicators (basically anything that a person can sense) such as audio output, haptic output and the like, may be used as a security indicator, and security indicators may be combined. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and computer security in general.

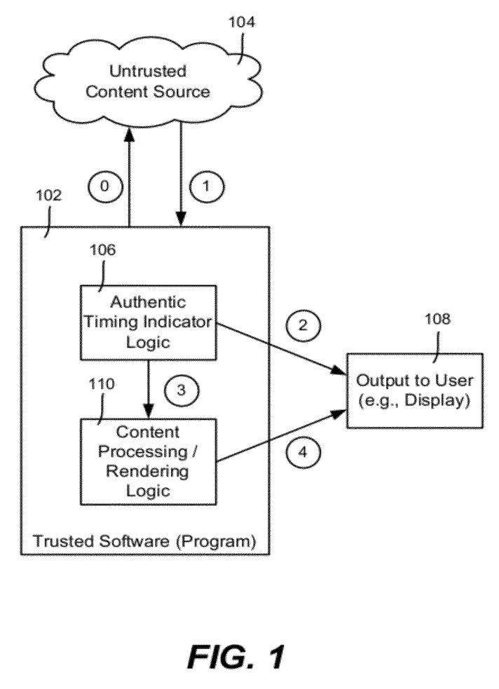

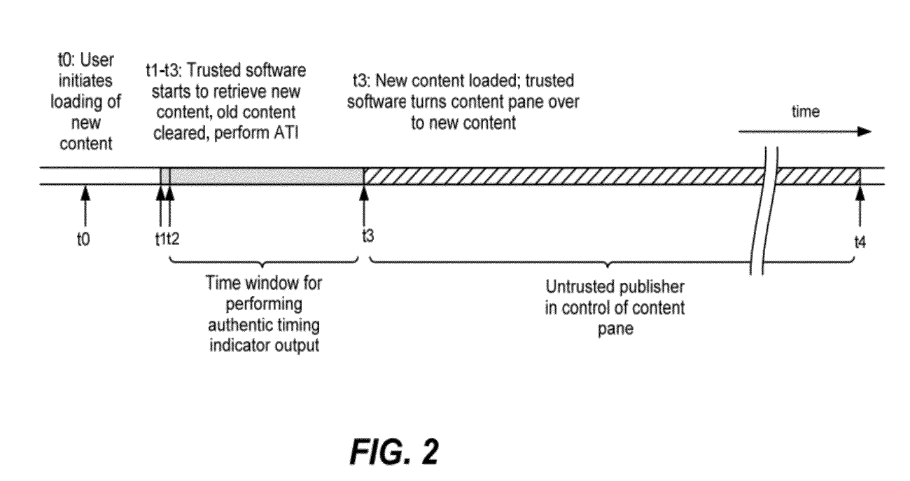

FIG. 1 is a block diagram showing example components of one system that uses authentic timing indicators to enhance computer system security. In general, trusted software 102 (e.g., a program) requests and receives content from an untrusted content source 104, such as a website or email server. This is represented in FIG. 1 by the arrows labeled zero (0) and one (1), which correspond to the times t0 and t1 in the timing diagram of FIG. 2.

As described below, authentic timing indicator logic 106 determines security information regarding the content, such as whether the connection to the website is secure, whether the website has an extended validation certificate (EV), whether an email message is signed, and so forth. Different logic may apply to different programs, e.g., a browser (or browser add-in) may be configured with one set of authentic timing indicator logic, and email application with another, and so forth.

Before the content source 104 is given control of the display (or any other output mechanism), the authentic timing indicator logic 106 outputs security-related information, comprising one or more authentic timing indicators (ATIs) to the user (the circled arrow labeled two (2) in FIG. 1), such as via a display as represented by block 108. This corresponds to the time window between t1 and t3 in FIG. 2 during which the authentic timing indicator is output, such as an animation to the display.

After the authentic timing indicator logic 106 completes the authentic timing indicator output and the new content is loaded, the logic 106 signals (the circled arrow labeled three (3) in FIG. 1) to the program's content processing/rendering logic 110 that the content may now be processed. In other words, the trusted software turns the content pane display area over to the new, untrusted content, which corresponds to the time window between t3 and t4 in FIG. 2.

As can be seen, because the authentic timing indicator output occurs before giving control to the untrusted content, the authentic timing indicators use time, rather than space, to establish authenticity. Users learn to recognize the timing and the action, which thus makes it difficult to spoof because even a virtually identical spoofed output can only occur following the initial output, which indicates the spoofing. While it is possible that an attacker can draw the same indicator to the content pane when the attacker's website is rendered to the screen, which may fool a user; users who understand that genuine indicators only appear once when they have navigated to a new page should not be fooled.

Moreover, in one implementation the user may customize/brand the properties of the authentic timing indicators. For example, for a visible indicator, this may include how long an authentic timing indicator appears, how it is animated, and other visible characteristics such as which color scheme is used. Further, a user can customize the image or set of images (e.g., a picture of the user's pet) that appears as a visible authentic timing indicator, whereby a spoofing attempt has no way to know what the user is expecting to see. Audio and haptic output may be customized as well, e.g., a part of a melody, a tone pattern, a vibration pattern, and so forth may be a customized user's authentic timing indicator.

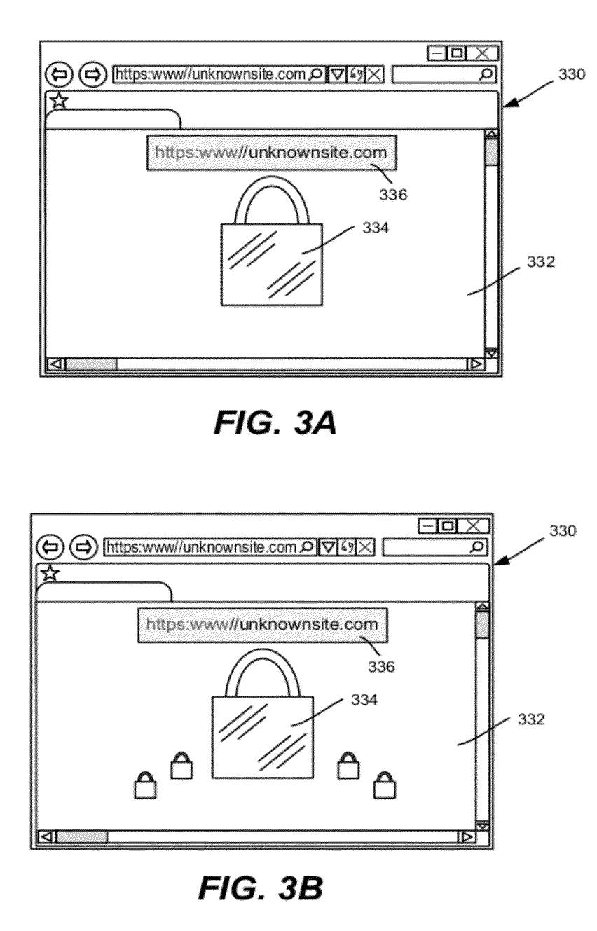

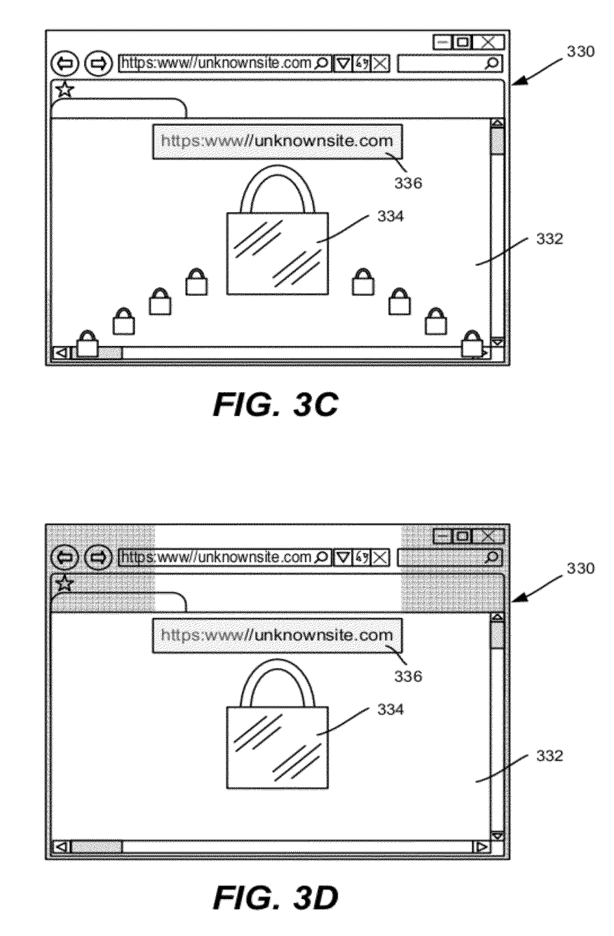

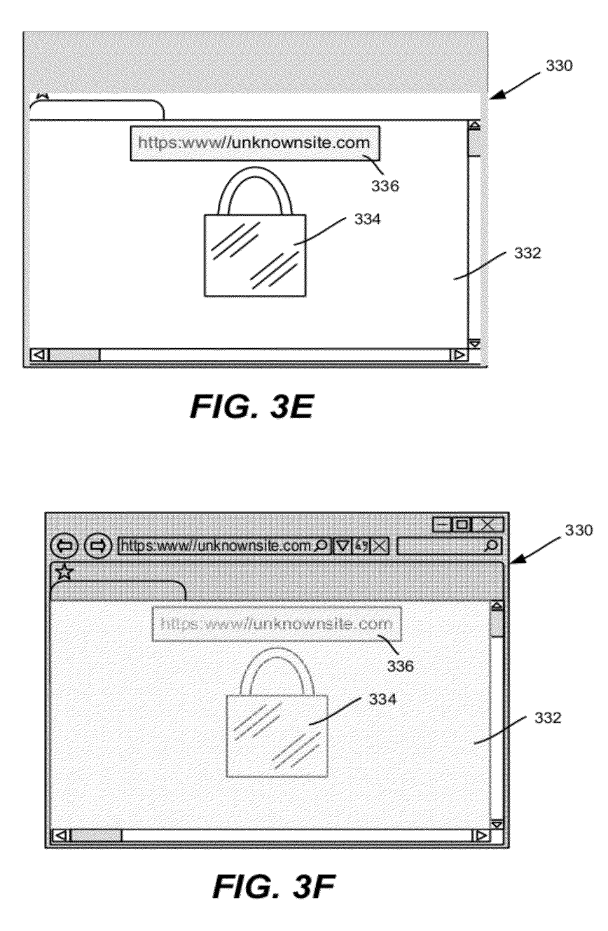

Turning to an example of a visible authentic timing indicator, FIGS. 3A-3F are representations of an example animated authentic timing indicator output for a secure site at various points in time in a browser environment 330. Note that while browser indicators like the well-known SSL lock appear in the browser chrome, authentic timing indicators may appear in the content pane 332, as they do (for awhile) in FIGS. 3A-3F. An advantage of showing authentic timing indicators in the content pane is that this is where users' attention is typically focused, so users are more likely to notice such indicators in the content pane.

In the specific example of a web browser, authentic timing indicators may appear before the browser renders page content. As long as the user knows that he or she has just navigated to a new page, and as long as the browser consistently shows an indicator every time before it renders a page, the user can verify that an indicator is genuine.

In the example of FIG. 3A the user sees an image 334 (a lock in this example, which instead may be a personalized image) before the page content is shown. Text 336 identifying the site may be present as well. In FIGS. 3B and 3C, an animation in the form of smaller locks that march into the browser chrome (by increasing in number and moving into the browser chrome then decreasing in number) is output. In FIGS. 3D and 3E, a color (shown as shaded gray) of the browser chrome that is representative of a security level starts to fill in the browser chrome, and becomes more fully saturated/less transparent until the color blocks out the chrome. For example, green may be used to represent the presence of an extended validation certificate, yellow for a secure site, and gray (or no color) for an unsecure site. In FIG. 3F, after the chrome is full, the authentic timing indicator and coloring fades out (becomes more transparent), after which control of the content pane 332 is given to the downloaded site content. Note that the time may be allowed to overlap, e.g., the content may fade in while the authentic timing indicator fades out. If desired, a static (or possibly animated) lock icon or the like may remain in the address bar (or elsewhere) for extra emphasis of the secure connection. Color may be used, e.g., the address bar background can remain green for extra emphasis of the secure connection and the extended validation certificate.

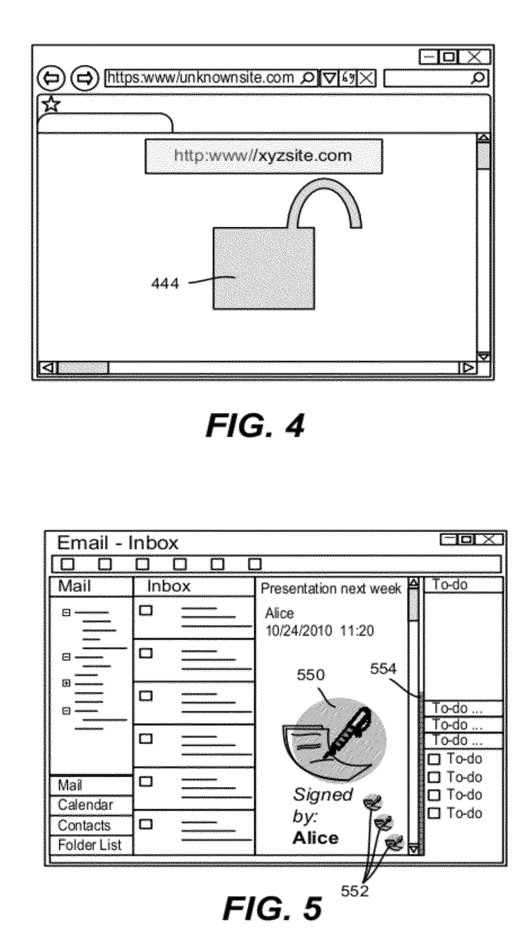

FIG. 4 shows a similar concept for an unsecure site, with an unlocked lock 444 as an image. In this way, the user is shown an authentic timing indicator as a tangible indicator of an unsecure site, (rather than having to rely on the user recognizing the absence of a secure indicator). Animation may be similarly used, such as with a different color scheme to emphasize non-secure. For example, although not separately shown, the site's URL and an unlocked padlock icon may appear in the browser's content pane; unlocked lock icons then march into the browser chrome, which fills up with color (grey, in the case of regular HTTP). When the chrome is full, the color may become fully saturated, then fade away along with the URL and lock icon in the content pane. Audio, haptic feedback and so forth may be output as well.

FIG. 5 is a representation of an email program using an authentic timing indicator animation to indicate a signed email message (shown at an instant in time in which a main icon 550 and smaller icons 552 are present, and colored output shown as shading 554 has started to increase. Although not shown, unsigned messages may be similarly emphasized using different icons/animations/coloring. Further, internal emails (e.g., from a corporate site) may be distinguished with authentic timing indicators from external emails.

As can be readily appreciated, authentic timing indicators can take on many graphical forms, including as exemplified in FIGS. 3A-3F, 4 and 5, e.g., as animations that start in a content pane and use iconography and/or text to give users the information they need to make correct security decisions. The animation may also guide the user's eyes towards an indicator (e.g., a static indicator) in the browser chrome or the trusted program's secure area. While a large lock icon (open for http connections and closed for https connections) is shown, personalized images may provide even more assurance as to non-spoofing. For a web browser, a large display of the domain being navigated to is shown, and for https connection to sites with an extended validation certificate, a colored (e.g., green) background is shown behind the domain name. For further protection against spoofing, the animation crosses from the content pane into the chrome/program's secure area, because attackers cannot draw into those spaces.

Note that in one implementation, an aspect of an authentic timing indicator is that the trusted software draws the authentic timing indicator every time the user initiates the decision-inducing action. For example, in a web browser, an authentic timing indicator is shown both for regular http connections as well as for secure https connections. If an authentic timing indicator is only shown for secure connections, an attacker may be able to lure a user to a fake site and spoof the authentic timing indicator of the genuine site, and if the user did not notice any difference and had no personalization, it may appear to the user as if they had gone to the genuine site. However, by showing an authentic timing indicator for every site, if an attacker lures the user to a fake site with a spoofed authentic timing indicator, the user will see two authentic timing indicators in a row, and should become suspicious.

Note that displaying a security indicator every time differs from the common practice of only showing an indicator for “secure” (e.g., https connections or signed email) situations, and showing nothing for the not-as-secure situations. Getting users to detect attacks by noticing the presence of a “non-security” indicator helps overcome the recognized reality that it is generally difficult to get users to detect attacks by noticing the absence of a security indicator. Notwithstanding, it is feasible to only output an authentic timing indictor for one or more security-related states and not others, e.g., only signed emails (which are relatively rare) get the authentic timing indictor, and not unsigned emails; a user may select such a preference, such as if it becomes too annoying to view the authentic timing indictor for every unsigned email. The timing also may be varied, e.g., a one second animation for signed emails, a one-half second animation for unsigned emails

If personalization is not used, a malicious page may spoof the indicator immediately upon loading, or capture the “onUnload” event before and spoof the indicator before it is cleared. In this case, the user will see multiple instances of the indicator animation, only one of which will be genuine (as discussed above). To address such a situation, users may personalize the indicator properties, and also be instructed to become suspicious if they see more than one indicator in sequence. Using the traditional “trusted-chrome” approach (as described above) may further help, by creating authentic timing indicator animations that draw both in the content pane and in the chrome; users may be educated to known that an indicator that does not cross the boundary from content pane to chrome is fake.

In Web browsers, sometimes the browser loads a page out of the user's sight, as when it “basket loads” pages in several tabs at the same time. In these situations, there is no opportunity to show an authentic timing indicator when the page loads. Instead, the authentic timing indicator may be shown as soon as the user switches to bring the page into view. In other words, if a page has been loaded into an out-of-sight tab, the authentic timing indicator is shown as soon as the user switches to that tab.

Another beneficial feature of authentic timing indicators is that they need not be on screen at all times; once the user has seen them, they no longer need to take up screen space. This property is desirable for mobile software, where screen space is limited and devoting space to chrome or fixed indicators takes space away from content. Even if there is no chrome at all (as may be the case in some mobile browsers that devote the full screen to content), authentic timing indicators can maintain their non-spoofability properties (e.g., as long as the user realizes that he or she has initiated a content change, the user knows the browser is in control and the authentic timing indicator is genuine).

The authentic timing indicator output may be relatively fast (e.g., on the order of a half second) to avoid annoying users with the added time to output the indicator; users may customize the timing. In the Web browser scenario, the authentic timing indicator can be shown as soon as a connection to a website has been made, as content is being downloaded, whereby the authentic timing indicator would be shown in lieu of the blank page normally shown today.

However, it remains possible that a user may miss the indicator, particularly if the time window is small. Software using authentic timing indicators may provide functionality for replaying the authentic timing indicator output on demand. For example, a web browser might provide a menu item that replays the authentic timing indicator for the current page. Note that an attacker's content cannot be allowed to capture whatever user action initiates the replay of the authentic timing indicator, e.g., the replay feature should not be triggered from clicks on Web pages, but rather only from clicks in chrome or secure-attention-sequences (a sequence of keystrokes/key combination guaranteed to be captured by trusted software).

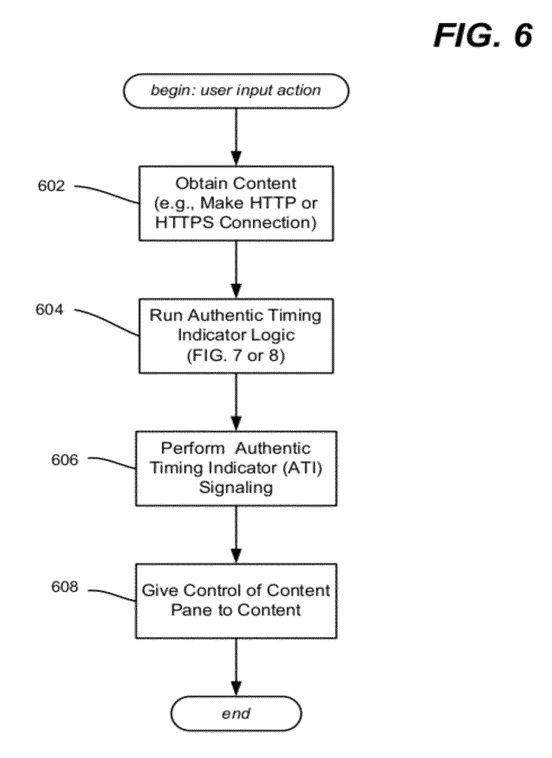

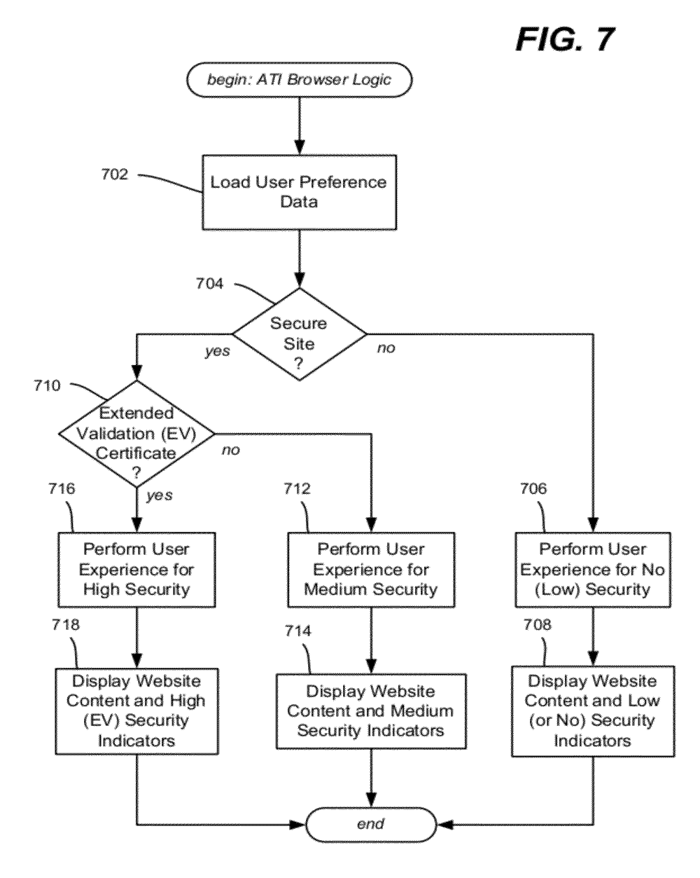

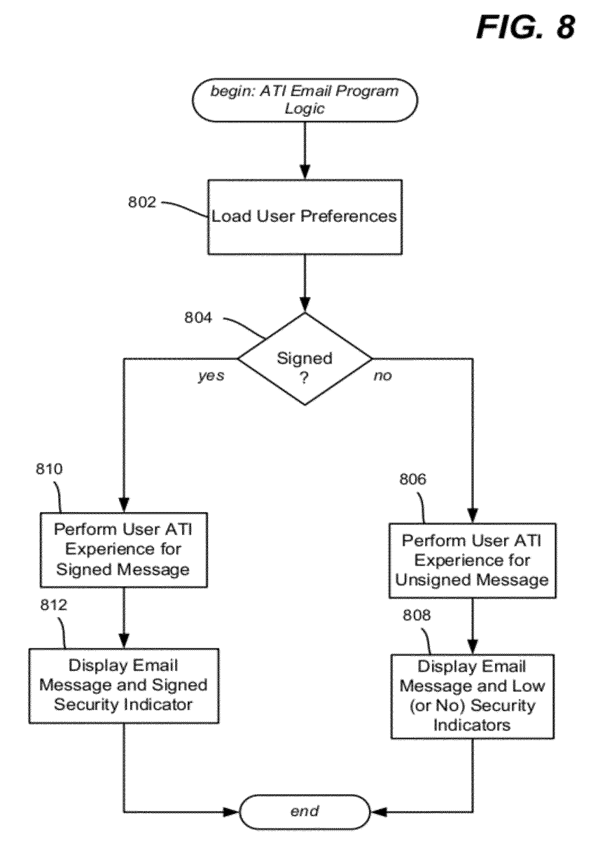

By way of summary, FIGS. 6-8 are flow diagrams representing example steps related to authentic timing indicator operations. Step 602 of FIG. 6 represents obtaining content, e.g., making the HTTP or HTTPs connection and request. Step 604 represents running the authentic timing indicator logic, as soon as the information needed to differentiate between which authentic timing indicator (ATI) to show is known. Step 606 represents performing the signaling, as described above. Steps 604 and 606 are further detailed in the example steps of FIGS. 7 and 8, which show the logic and output for a web browser program (FIG. 7) and an email program (FIG. 8). Step 608 represents giving control of the content pane to the content, after the authentic timing indicator output.

FIG. 7 shows the logic and output for a web browser program, beginning at step 702 where any user preference data is loaded. This allows for personalization of timing, color (e.g., different schemes for colorblind users), custom images, sounds, animations and so forth. Note that some or all of the personalization may be performed ahead of any user action, e.g., the user preference data may be used to configure each authentic timing indicator as desired, whereby it is used in that configuration thereafter unless and until re-configured. Thus, some or all of step 702 may be performed in advance of a user request for content or other such action.

Step 704 evaluates whether the site is a secure site. If not, step 706 is performed, which outputs the low security authentic timing indicator user experience, e.g., unlocked lock icon animation, gray color scheme, and so forth. Step 708 represents rendering the website content, with a low (or no) security indicator in the browser chrome, if desired.

If the site is secure, step 710 is performed, which represents evaluating whether the site has an extended validation certificate. If not, step 710 branches to step 712 which outputs the medium security authentic timing indicator user experience, e.g., locked lock icon animation, yellow color scheme, and so forth. Step 714 represents rendering the website content, with a medium security indicator in the browser chrome, if desired, e.g., a lock icon with a yellow (or no) color in the address bar.

If instead at step 710 the site is determined to have an extended validation certificate, step 710 branches to step 716 which outputs the high security authentic timing indicator user experience, e.g., locked lock icon animation, green color scheme, and so forth. Step 714 represents rendering the website content, with a high security indicator in the browser chrome, if desired, e.g., a lock icon with a green color in the address bar.

FIG. 8 is an example flow diagram for authentic timing indicator logic in email program, beginning at step 802 where any user preference data is loaded to allow for personalization. Step 804 evaluates the email message to be displayed in the content pane to determine whether the message has been appropriately signed. If not, step 806 provides the unsigned user authentic timing indicator experience, before step 808 is performed to display the message (and any security indicator in the trusted program's secure area). Otherwise, step 810 provides the signed user authentic timing indicator experience, before step 812 is performed to display the message (and any security indicator in the trusted program's secure area).

Note that FIG. 8 is only one example for email authentic timing indicator logic. Additional decisions may be used to provide authentic timing indicator output that differs for internal versus external messages, trusted senders, known spoofed senders, and so forth.

As can be seen, there is provided authentic timing indicators whose authenticity is recognized by when they appear, which is before control is handed over to third-party content. Authentic timing indicators appear in response to a user-initiated action, and do so consistently in response to that action. Authentic timing indicators may take on multiple possible appearances, and do so based upon the security characteristics of the user-initiated action (e.g., secure versus unsecure, signed versus unsigned). a Web browser might show an unlocked padlock for an HTTP connection, but a locked padlock for an HTTPS connection)

### Exemplary Operating Environment

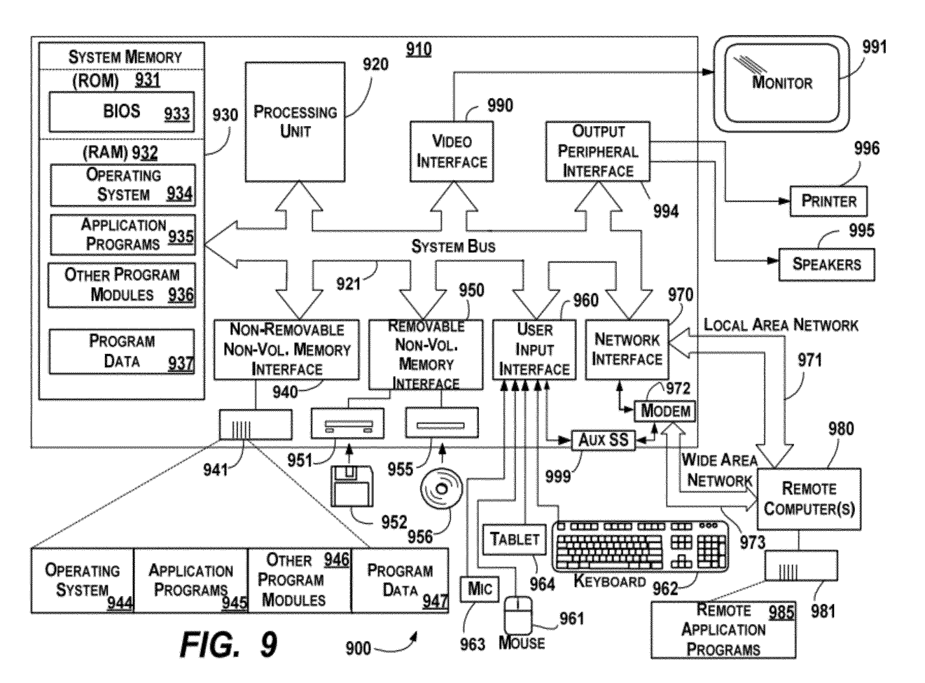

FIG. 9 illustrates an example of a suitable computing and networking environment 900 on which the examples of FIGS. 1-8 may be implemented. The computing system environment 900 is only one example of a suitable computing environment and is not intended to suggest any limitation as to the scope of use or functionality of the invention. Neither should the computing environment 900 be interpreted as having any dependency or requirement relating to any one or combination of components illustrated in the exemplary operating environment 900.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 9, an exemplary system for implementing various aspects of the invention may include a general purpose computing device in the form of a computer 910. Components of the computer 910 may include, but are not limited to, a processing unit 920, a system memory 930, and a system bus 921 that couples various system components including the system memory to the processing unit 920. The system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 910 typically includes a variety of computer-readable media. Computer-readable media can be any available media that can be accessed by the computer 910 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 910. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 930 includes computer storage media in the form of volatile and/or nonvolatile memory such as read only memory (ROM) 931 and random access memory (RAM) 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 9 illustrates operating system 934, application programs 935, other program modules 936 and program data 937.

The computer 910 may also include other removable/non-removable, volatile/nonvolatile computer storage media. By way of example only, FIG. 9 illustrates a hard disk drive 941 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media, described above and illustrated in FIG. 9, provide storage of computer-readable instructions, data structures, program modules and other data for the computer 910. In FIG. 9, for example, hard disk drive 941 is illustrated as storing operating system 944, application programs 945, other program modules 946 and program data 947. Note that these components can either be the same as or different from operating system 934, application programs 935, other program modules 936, and program data 937. Operating system 944, application programs 945, other program modules 946, and program data 947 are given different numbers herein to illustrate that, at a minimum, they are different copies. A user may enter commands and information into the computer 910 through input devices such as a tablet, or electronic digitizer, 964, a microphone 963, a keyboard 962 and pointing device 961, commonly referred to as mouse, trackball or touch pad. Other input devices not shown in FIG. 9 may include a joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. The monitor 991 may also be integrated with a touch-screen panel or the like. Note that the monitor and/or touch screen panel can be physically coupled to a housing in which the computing device 910 is incorporated, such as in a tablet-type personal computer. In addition, computers such as the computing device 910 may also include other peripheral output devices such as speakers 995 and printer 996, which may be connected through an output peripheral interface 994 or the like.

The computer 910 may operate in a networked environment using logical connections to one or more remote computers, such as a remote computer 980. The remote computer 980 may be a personal computer, a server, a router, a network PC, a peer device or other common network node, and typically includes many or all of the elements described above relative to the computer 910, although only a memory storage device 981 has been illustrated in FIG. 9. The logical connections depicted in FIG. 9 include one or more local area networks (LAN) 971 and one or more wide area networks (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other means for establishing communications over the WAN 973, such as the Internet. The modem 972, which may be internal or external, may be connected to the system bus 921 via the user input interface 960 or other appropriate mechanism. A wireless networking component such as comprising an interface and antenna may be coupled through a suitable device such as an access point or peer computer to a WAN or LAN. In a networked environment, program modules depicted relative to the computer 910, or portions thereof, may be stored in the remote memory storage device. By way of example, and not limitation, FIG. 9 illustrates remote application programs 985 as residing on memory device 981. It may be appreciated that the network connections shown are exemplary and other means of establishing a communications link between the computers may be used.

An auxiliary subsystem 999 (e.g., for auxiliary display of content) may be connected via the user interface 960 to allow data such as program content, system status and event notifications to be provided to the user, even if the main portions of the computer system are in a low power state. The auxiliary subsystem 999 may be connected to the modem 972 and/or network interface 970 to allow communication between these systems while the main processing unit 920 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
determining from security-related information associated with content which state of a plurality of available states is associated with the content; and
for at least one of the states, outputting an authentic timing indicator corresponding to that state when the content is associated with that state, before allowing the content to control a content output area of a trusted program.

2. The method of claim 1 further comprising, configuring at least one property of the authentic timing indicator based upon user preference data.

3. The method of claim 1 wherein the content is obtained via a browser program, wherein the security-related information corresponds to one state of a plurality of possible states including a first state corresponding to a secure site, a second state corresponding to a secure site with an extended validation certificate, or a third state comprising an unsecure site, and wherein outputting the authentic timing indicator comprises outputting a secure site-related indicator when the security-related information corresponds to the first state, outputting an extended validation certificate-related indicator when the security-related information corresponds to the second state, or outputting an unsecure site-related indicator when the security-related information corresponds to the third state.

4. The method of claim 1 wherein the content is obtained via an email program, wherein the security-related information corresponds to one state comprising a signed message or another state comprising an unsigned message, and wherein outputting the authentic timing indicator comprises outputting an indicator when the security-related information corresponds to the one state.

5. The method of claim 1 wherein the content is obtained via an email program, wherein the security-related information corresponds to one state comprising a signed message or another state comprising an unsigned message, and wherein outputting the authentic timing indicator comprises outputting a first indicator when the security-related information corresponds to the first state, and outputting a second indicator that is different from the first indicator when the security-related information corresponds to the second state.

6. The method of claim 1 wherein outputting the authentic timing indicator comprises outputting a first image when the security-related information corresponds to one state, and outputting a second image that is different from the first image when the security-related information corresponds to another state.

7. The method of claim 1 wherein outputting the authentic timing indicator comprises outputting a first animation when the security-related information corresponds to one state, and outputting a second animation that is different from the first animation when the security-related information corresponds to another state.

8. The method of claim 7 wherein outputting the first animation when the security-related information corresponds to one state comprises providing an appearance of an icon moving from a content output area into a secure screen area of a trusted program.

9. The method of claim 1 wherein outputting the authentic timing indicator comprises outputting visible data including a first color when the security-related information corresponds to one state, and outputting visible data including a second color that is different from the first color when the security-related information corresponds to another state.

10. The method of claim 1 wherein outputting the authentic timing indicator comprises outputting audio output or haptic output, or outputting both audio output and haptic output.

11. The method of claim 1 further comprising, detecting a user interaction request to replay the output of the authentic timing indicator, and replaying the authentic timing indicator in response to the request.

12. In a computing environment, a system comprising, a trusted program configured to obtain untrusted content, the trusted program coupled to authentic timing indicator logic, the authentic timing indicator logic configured to select a selected authentic timing indicator based upon security-related information associated with the untrusted content, and to output the selected authentic timing indicator using timing to call attention to the output of the authentic timing indicator relative to output of the untrusted content.

13. The system of claim 12 wherein the authentic timing indicator logic outputs the authentic timing indicator to a content pane of the trusted program before the trusted program outputs the untrusted content to the content pane, including giving control of the content pane to the untrusted content.

14. The system of claim 12 wherein the authentic timing indicator logic outputs the authentic timing indicator to a content pane of the trusted program and to a secure area of the trusted program that is unable to be controlled by the untrusted content.

15. The system of claim 12 wherein the authentic timing indicator comprises an animation of at least one icon and colored output.

16. The system of claim 12 wherein the authentic timing indicator is personalized based upon user preference data.

17. The system of claim 12 wherein the trusted program comprises a browser program or an email program.

18. One or more computer-readable media having computer-executable instructions, which when executed perform steps, comprising:
obtaining content and security-related information related to the content;
outputting an authentic timing indicator based upon the security-related information for a first period of time; and
rendering at least some of the content in a second period of time that begins after the first period of time begins.

19. The one or more computer-readable media of claim 18 wherein the content is obtained by a browser and wherein the security-related information related to the content comprises information regarding a secure or non-secure connection to the site, and wherein outputting the authentic timing indicator comprises outputting a first animation when the site corresponds to a secure connection, and a second animation that is different from the first animation when the site corresponds to a non-secure connection.

20. The one or more computer-readable media of claim 18 having further computer-executable instructions comprising, configuring the automatic timing indicator based upon user preference data.
